(19) United States
(12) Patent Application Publication
(10) Pub. No.: US 2010/0315743 A1
(43) Pub. Date: Dec. 16, 2010

(54) MAGNETIC READ/WRITE HEAD SUBSTRATE

(75) Inventors: Yucong WANG, Kagoshima (JP); Shuji Nakazawa, Kagoshima (JP); Takuya Gentsu, Shiga (JP)

Correspondence Address: BIRCH STEWART KOLASCH & BIRCH, PO BOX 747, FALLS CHURCH, VA, 22040-0747, US

(73) Assignee: KYOCERA Corporation, Fushimi-ku (JP)

(21) Appl. No.: 12/740,692

(22) Filed: Apr. 29, 2010

Related U.S. Application Data
(63) Continuation-in-part of application No. PCT/JP2008/069685, filed on Oct. 29, 2008.

(30) Foreign Application Priority Data
Oct. 29, 2007 (JP) 2007-279852

(51) Int. Cl. G11B 15/64; G11B 5/33

(52) U.S. Cl. 360/235.1; 428/813; 428/815.1; G9B/15.083

(57) ABSTRACT

A substrate for a magnetic read/write head is disclosed. The substrate can reduce detachment of crystal grains when unexpected vibrations or impacts are applied. The substrate may be machined when the substrate is cut into strips or a flow path surface recess is formed to produce the magnetic read/write head. The reduced detachment of crystal grains makes the magnetic read/write head more resilient to chipping, which allows the magnetic read/write head to have good performance in read/write.

### CROSS-REFERENCE TO RELATED APPLICATION

The present application is a continuation in part based on PCT application No. JP2008/069685, filed on Oct. 29, 2008, which claims priority to Japanese patent application No. 2007-279852, filed on Oct. 29, 2007 entitled “MAGNETIC HEAD SUBSTRATE, MAGNETIC HEAD AND READING MEDIUM DRIVE DEVICE”, the content of which is incorporated by reference herein in their entirety.

### FIELD

Embodiments of the present disclosure generally relate to substrates for a magnetic head, and more particularly relate to substrates for a magnetic head used in a recording medium drive device.

### BACKGROUND

An example of a magnetic head for recording and reproduction is a magnetic head in which an electromagnetic conversion element is mounted on a slider that flies above and moves relative to a recording medium. Such a magnetic head can be produced by a method as follows. First, an insulating film composed of amorphous alumina is formed on a ceramic substrate composed of an Al₂O₃—TiC ceramic, and a plurality of electromagnetic conversion elements are then formed on the insulating film.

Subsequently, the ceramic substrate having the electromagnetic conversion elements thereon is cut into strips, and a cut surface is polished to form a mirror-finished surface. A part of the mirror-finished surface is then removed by an ion-milling method or a reactive ion etching method to form a flow path surface. Subsequently, the strip-shaped ceramic substrate is divided into chips, thus obtaining a magnetic head in which an electromagnetic conversion element is mounted on a slider.

For a recording medium drive device, such as a hard disk drive, in which such a magnetic head is installed, an increase in a storage capacity has been increasingly desired and a higher recording density has been required. To meet these requirements, it is required to markedly reduce a flying height (flying amount) of the magnetic head from a magnetic disk serving as a recording medium to 10 nm or less. In a case of such a small flying height (flying amount), the magnetic head produced as described above may contact the recording medium. Accordingly, it is desired that crystal grains of a composition of a slider constituting the magnetic head be not readily detached by the impact of this contact.

In the Al₂O₃—TiC material of the magnetic head slider, it may be difficult to reduce the grain growth of Al₂O₃ crystal grains. In such a case, abnormal grain growth of Al₂O₃ crystal grains may occur. As a result, detachment of the Al₂O₃ crystal grains from a cut surface or a flow path surface of the slider may readily occur in the case where a magnetic head contacts a hard disk when, for example, unexpected vibrations or impacts are applied.

Accordingly, it is desired to reduce detachment of crystal grains from a cut surface or a flow path surface of a slider.

### SUMMARY

A substrate for a magnetic read/write head is disclosed. The substrate can reduce detachment of crystal grains in the substrates. The reduced detachment of crystal grains makes the magnetic read/write head more resilient to damage, which allows the magnetic read/write head to have good performance in read/write.

A first embodiment comprises a substrate for a magnetic head. The substrate comprising a sinter comprising at least about 60% by mass and at most about 70% by mass alumina and at least about 30% by mass and at most about 40% by mass TiC_{X}O_{Y}N_{Z} where the X, Y and Z satisfy 0.5≦X≦0.993, 0.005≦Y≦0.30, 0.002≦Z≦0.20, and 0.507≦X+Y+Z≦1. A first value comprises a number of crystal grains of the TiC_{X}O_{Y}N_{Z} present on an arbitrary straight line having a length of at least about 10 μm on a cut surface of the sinter. A second value comprises a total of the first value and a number of crystal grains of alumina present on the arbitrary straight line, and a proportion of the first value to the second value is at least about 55% and at most about 75%.

A second embodiment comprises a magnetic head. The magnetic head comprises a slider comprising a sinter. The sinter comprises at least about 60% by mass and at most about 70% by mass alumina and at least about 30% by mass and at most about 40% by mass TiC_{X}O_{Y}N_{Z} where the X, Y and Z satisfy 0.5≦X≦0.993, 0.005≦Y≦0.30, 0.002≦Z≦0.20, and 0.507≦X+Y+Z≦1. A first value comprises a number of crystal grains of the TiC_{X}O_{Y}N_{Z} present on an arbitrary straight line having a length of at least about 10 μm on a cut surface of the sinter. A second value comprises a total of the first value and a number of crystal grains of alumina present on the arbitrary straight line. A proportion of the first value to the second value is at least about 55% and at most about 75%. An electromagnetic conversion element is provided on the slider.

A third embodiment comprises a recording medium drive device. The recording medium drive device comprises a magnetic head comprising an electromagnetic conversion element provided on a slider. The magnetic head comprises a sinter comprising at least about 60% by mass and at most about 70% by mass alumina and at least about 30% by mass and at most about 40% by mass TiC_{X}O_{Y}N_{Z} where the X, Y and Z satisfy 0.5≦X≦0.993, 0.005≦Y≦0.30, 0.002≦Z≦0.20, and 0.507≦X+Y+Z≦1. A first value comprises a number of crystal grains of the TiC_{X}O_{Y}N_{Z} present on an arbitrary straight line having a length of at least about 10 μm on a cut surface of the sinter. A second value comprises a total of the first value and a number of crystal grains of alumina present on the arbitrary straight line. A proportion of the first value to the second value is at least about 55% and at most about 75%. The recording medium device further comprises a recording medium comprising a magnetic recording layer operable to record and reproduce information using the magnetic head, and a motor operable to drive the recording medium.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the disclosure. The figures are provided to facilitate understanding of the disclosure without limiting the breadth, scope, scale, or applicability of the disclosure. The drawings are not necessarily made to scale.

FIG. 1 is an illustration of a plane view of a recording medium drive device according to an embodiment of this disclosure.

FIG. 2 is an illustration of a sectional view taken along to a line II-II in FIG. 1.

FIG. 3 is an illustration of a sectional view taken along to a line III-III in FIG. 1.

FIG. 4 is an illustration of an expanded perspective view of a magnetic head in a recording medium drive device according to an embodiment of the disclosure.

FIG. 5 is an illustration of a perspective bottom view of the magnetic head shown in FIG. 4.

FIG. 6A is an illustration of a perspective view of a substrate for a magnetic head according to an embodiment of the disclosure.

FIG. 6B is an illustration of a perspective view of a substrate for a magnetic head according to an embodiment of the disclosure.

FIG. 7 is an illustration of a sectional view of a substantial part of a pressure-sintering apparatus showing a state in which a compact is located in the pressure sintering-apparatus according to an embodiment of the disclosure.

FIG. 8 is an illustration of a perspective view showing a process in which an electromagnetic conversion element is formed on the substrate for a magnetic head according to an embodiment of the disclosure.

FIG. 9A and FIG. 9B are illustrations of perspective views showing a process in which a substrate for a magnetic head is cut into strips according to an embodiment of the disclosure.

FIGS. 10A and 10B are illustrations of perspective views showing a process in which a magnetic head is formed from strips according to an embodiment of the disclosure.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. Furthermore, there is no intention to be bound by any expressed or implied theory presented in the preceding technical field, background, brief summary or the following detailed description. The present disclosure should be accorded scope consistent with the claims, and not limited to the examples described and shown herein.

Embodiments of the disclosure are described herein in the context of practical non-limiting applications, namely a read/write head for a hard disk drive. Embodiments of the disclosure, however, are not limited to such hard disc drives, and the techniques described herein may also be utilized in other recording medium drive devices. For example, embodiments may be applicable to tape drives.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

The following description is presented to enable a person of ordinary skill in the art to make and use the embodiments of the disclosure. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the embodiments of the present disclosure. Thus, the embodiments of the present disclosure are not intended to be limited to the examples described herein and shown, but are to be accorded the scope consistent with the claims.

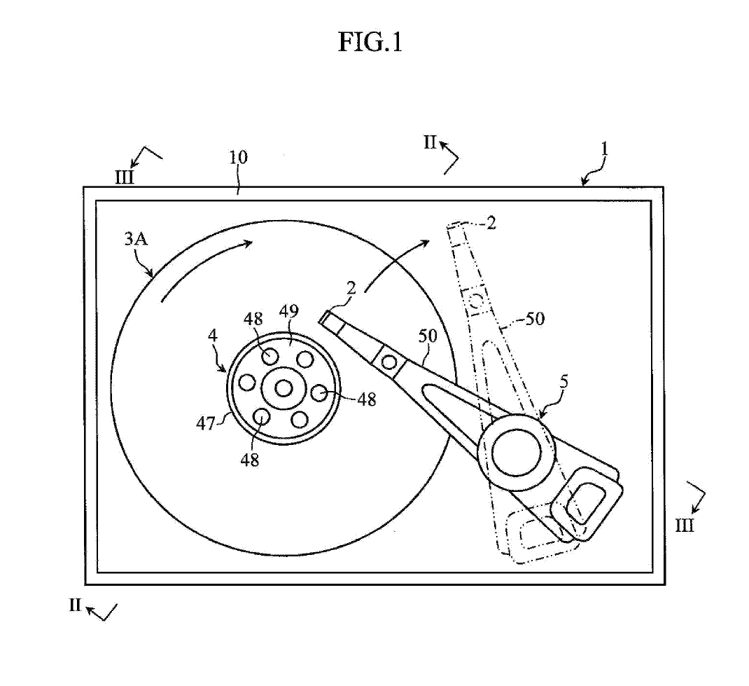

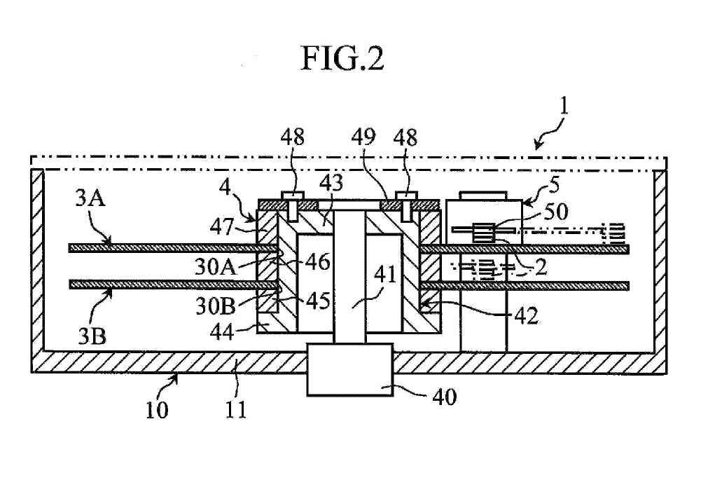

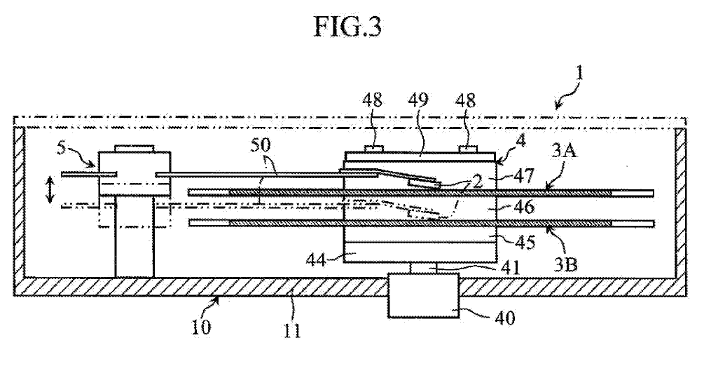

FIG. 1 is an illustration of a plane view of a recording medium drive device 1 (hard disk drive 1) according to an embodiment of this disclosure. FIG. 2 is an illustration of a sectional view taken along a line II-II in FIG. 1. FIG. 3 is an illustration of a sectional view taken along a line III-III in FIG. 1.

The hard disk drive 1 comprises a case 10 enclosing a magnetic head 2, magnetic disk 3A and magnetic disk 3B, and a rotation drive mechanism 4. The magnetic head 2 accesses any track of a mirror-finished surface of the magnetic disks 3A or 3B to record and reproduce information. The magnetic head 2 is supported by an actuator 5 with a suspension arm 50 therebetween, and is configured to move on the magnetic disks 3A and 3B in a non-contact manner. More specifically, the magnetic head 2 can rotate in a radial direction of the magnetic disks 3A and 3B around the actuator 5 and reciprocally move in the vertical direction. The magnetic head 2 comprises an electromagnetic conversion element 20 and a slider 21.

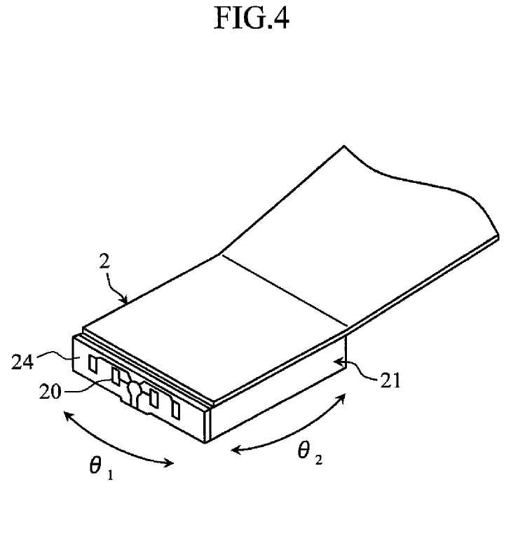

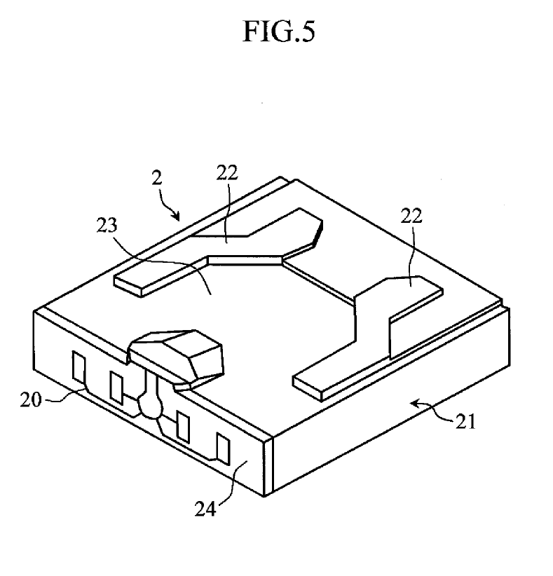

FIG. 4 is an illustration of an expanded perspective view of a magnetic head in a recording medium drive device according to an embodiment of the disclosure. FIG. 5 is an illustration of a perspective bottom view of the magnetic head shown in FIG. 4. As shown in FIG. 4-5, the magnetic head in the recording medium drive device comprises an electromagnetic conversion element 20, a slider 21, a flying surface 22, a flow path surface 23, and an insulating film 24.

The electromagnetic conversion element 20 is operable to exhibit a magnetoresistive effect. The electromagnetic conversion element 20 may be, for example and without limitation, a magnetoresistive (MR) element, a giant magnetoresistive (GMR) element, a tunnel magnetoresistive (TMR) element, and the like. The electromagnetic conversion element 20 may be arranged on a surface of the insulating film 24 provided on an end face of the slider 21.

The slider 21 is a base of the magnetic head 2 and comprises a flying surface 22 and a flow path surface 23. The flying surface 22 is a surface facing the magnetic disks 3A and 3B, and formed as a mirror-finished surface. When the magnetic head 2 is driven, a flying height of the flying surface 22 relative to the magnetic disk 3A is, for example but without limitation, 10 nm or less. The flow path surface 23 functions as a flow path for passing through air for making the magnetic head 2 fly. The flow path surface 23 is formed by, for example but without limitation, an ion-milling method, a reactive ion etching method or the like. A depth of the flow path surface 23 from the flying surface 22 is, for example but without limitation, in a range of about 1.5 to about 2.5 μm. An arithmetic mean roughness (Ra) of the flow path surface 23 is, for example but without limitation, greater than zero nm but at most about 15 nm.

Flying characteristics of the magnetic head 2 are affected by surface properties of the flow path surface 23 provided on the slider 21. The Ra is an indicator of the surface properties. Therefore, by controlling the Ra of the flow path surface 23 to be about 15 nm or less, generation of a turbulent flow on the flow path surface 23 can be reduced. In this manner, the flying characteristics of the magnetic head 2 can be stabilized. Herein, the term “flying characteristics of the magnetic head 2” refers to rolling characteristic and pitching characteristic of the magnetic head 2. The rolling characteristic is a flying characteristic in the direction shown by arrow θ1 in FIG. 4. The pitching characteristic is a flying characteristic in the direction shown by arrow 82 in FIG. 4.

The Ra of the flow path surface 23 can be measured using an atomic force microscope in accordance with, for example but without limitation, the JIS B 0601-2001 measurement standard, and the like. When a size of the slider 21 (flow path surface 23) is small, a measurement length specified in this JIS standard may be set to about 10 μm and the Ra of the flow path surface 23 may be measured.

The magnetic disks 3A and 3B (FIG. 2) are each examples of the recording medium and each have a disc shape having through-holes 30A and 30B, respectively. Each of the magnetic disks 3A and 3B comprise a magnetic recording layer (not shown).

As shown in FIG. 2, the rotation drive mechanism 4 can rotate the magnetic disks 3A and 3B and comprises a motor 40 and a rotating shaft 41. The motor 40 provides the rotating shaft 41 with a torque and is coupled to a bottom wall 11 of the case 10. The rotating shaft 41 is operable to rotate by the motor 40 and supports the magnetic disks 3A and 3B. A hub 42 is coupled to the rotating shaft 41. The hub 42 is operable to rotate together with the rotating shaft 41 and comprises an insertion portion 43 and a flange portion 44. The magnetic disks 3A and 3B are stacked on the flange portion 44, with spacers 45, 46, and 47 therebetween, in a state in which the through-holes 30A and 30B are fitted in the insertion portion 43. The magnetic disks 3A and 3B are further coupled to the hub 42 and the rotating shaft 41 by coupling a clamp 49 to the spacer 47 with screws 48. In practice, in the rotation drive mechanism 4, the hub 42 and the magnetic disks 3A and 3B are operable to rotate by rotating the rotating shaft 41 using the motor 40.

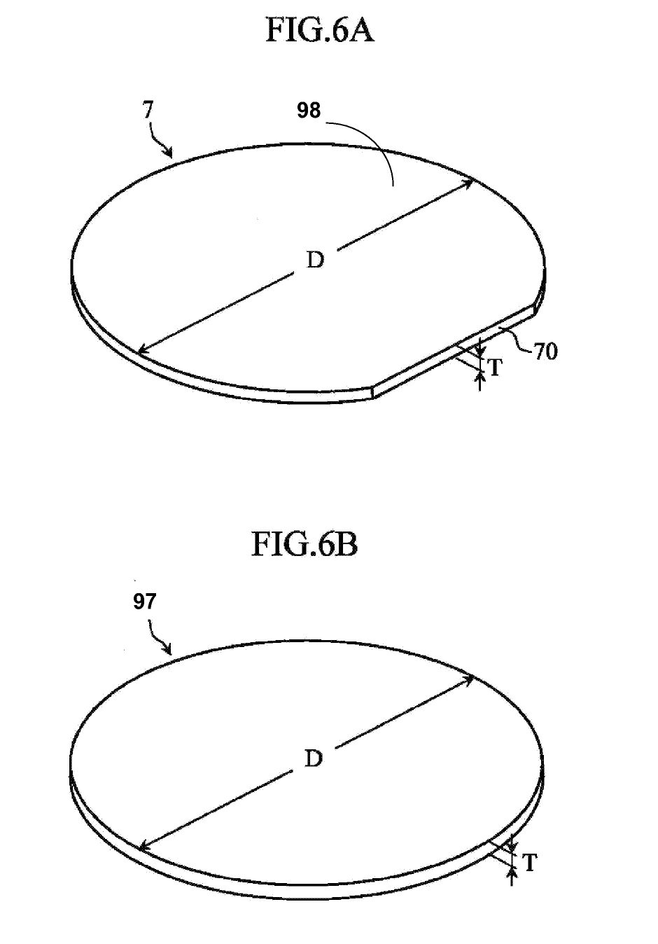

A method of producing the magnetic head 2 is described below with reference to FIGS. 6A to 10B.

First, a substrate 7 for a magnetic head as shown in FIG. 6A, or a substrate 97 for a magnetic head as shown in FIG. 6B, is prepared. The substrate 7 is prepared by forming an orientation flat 70 in a disc-shaped substrate 97. The orientation flat 70 is used for positioning the substrate 7 when electromagnetic conversion elements 20 are mounted on the sliders 21 or when the substrate 7 is cut into strips. This orientation flat 70 can be formed by cutting a part of the substrate 97 shown in FIG. 6B with a dicing saw.

The substrate 7/97 has both of sufficient electrical conductivity and sufficient machinability. The substrate 7/97 comprises a sinter having a diameter D in a range of about 102 to about 153 mm and a thickness T in a range of about 1.2 to about 2 mm. The substrate 7/97 comprises a composite sinter comprising alumina (Al₂O₃) crystal grains and TiCₓO_{y}Nₓ crystal grains as an accessory component.

The Al₂O₃ is a component for ensuring a machinability, abrasion resistance, and heat resistance of the sinter such as the substrate 7/97 for the magnetic head 2. The machinability of the sinter can be evaluated by, for example, measuring an amount of lapping per unit time in a lapping process. The content of the Al₂O₃ in the sinter is about 60% by mass or more and about 70% by mass or less.

The TiCₓO_{y}Nₓ is a component for adjusting the electrical conductivity and the fracture toughness of the sinter such as the substrate 7/97 for the magnetic head 2. The electrical conductivity of the sinter can be evaluated in terms of, for example, a volume resistivity. The volume resistivity can be measured, for example but without limitation, in accordance with the JIS C 2141-1992. The volume resistivity of the sinter may be about 2×10⁻¹ Ω·m or less, or about 2×10⁻³ Ω·m or less. The content of the TiCₓO_{y}Nₓ in the sinter is about 30% by mass or more and about 40% by mass or less. The content of TiC_{X}O_{Y}N_{Z} in the substrate 7, 7′ for magnetic heads affects the electrical conductivity and machinability. Specifically, when the content of TiC_{X}O_{Y}N_{Z} is small, the volume resistivity increases and thus the electrical conductivity decreases. When the content of TiC_{X}O_{Y}N_{Z} is large, the toughness of the substrate 7, 7′ for magnetic heads increases and thus the machinability decreases. When the content of the TiC_{X}O_{Y}N_{Z} in the sinter is about 30% by mass or more, the sinter can have a high electrical conductivity. Accordingly, when the electromagnetic conversion element 20 is charged in the magnetic head 2 comprising the substrate 7/97, electric charges can be substantially immediately removed. On the other hand, when the content of the TiC_{X}O_{Y}N_{Z} in the sinter is about 40% by mass or less, in a sintering step described below, formation of micropores (pores having a diameter in the range of about 100 to about 500 nm) inside the sinter can be reduced. Accordingly, detachment of crystal grains can be reduced in a process after the sintering step. Examples of the process after the sintering step comprise the cutting of the substrate 7/97 and the formation of the flow path surface 23 by an ion-milling method or a reactive ion etching method.

To determine mass % of the Al₂O₃ and the TiC_{X}O_{Y}N_{Z} in the sinter, contents of Aluminum (Al), Titanum (Ti), Carbon (C), Oxygen (O₂) and Nitride (N₂). The contents of Aluminum (Al) and Titanum (Ti) can be obtained by X-ray fluorescence analysis or inductively coupled plasma (ICP) emission spectroscopy. The contents of Carbon (C), Oxygen (O₂) and Nitride (N₂) can be obtained with a carbon analyzer and an oxygen/nitrogen analyzer. The mass percent of Al₂O₃ is determined by converting the obtained Al content to the oxide thereof. The O₂ content of TiC_{X}O_{Y}N_{Z} is determined by subtracting the O₂ content required for this conversion of the obtained Al content to the oxide from the O₂ content obtained by the oxygen/nitrogen analyzer. The mass percent of TiC_{X}O_{Y}N_{Z} is determined by adding the contents of C, N₂, and Ti to this O₂ content of TiC_{X}O_{Y}N_{Z}.

Here, in TiC_{X}O_{Y}N_{Z}, X, Y, and Z satisfy the relationships 0.5≦X≦0.993, 0.005≦Y≦0.30, 0.002≦Z≦0.20, and 0.507≦X+Y+Z≦1.

The crystal structure of TiC_{X}O_{Y}N_{Z} is the NaCl-type crystal structure, and TiC_{X}O_{Y}N_{Z} has a structure in which some of carbon atoms in TiC are replaced with oxygen and nitrogen atoms. It is important to control the number X of carbon atoms of TiC_{X}O_{Y}N_{Z} in the sinter (substrate 7, 7′ for magnetic heads) to be in the range of 0.5 to 0.993. By controlling the number X of carbon atoms within this range, the hardness of TiC_{X}O_{Y}N_{Z} can be increased and the bonding strength with Al₂O₃ can be increased. Accordingly, detachment of TiC_{X}O_{Y}N_{Z} crystal grains can be reduced. In particular, the number X of carbon atoms may be in the range of 0.7 to 0.9. In the case where the number X of carbon atoms is not less than 0.5, the hardness of TiC_{X}O_{Y}N_{Z} can have less likely excessive low value, and thus abrasion in contact-start-stop (CSS) can less likely occur. In the case where the number X of carbon atoms is not more than 0.993, the number Y of oxygen atoms can be kept with sufficient value, that is, a capacity of TiC_{X}O_{Y}N_{Z} for containing oxygen can be kept with sufficient value. Consequently, the bonding strength with Al₂O₃ can be kept high, thereby reducing detachment of crystal grains.

It is important to control the number Y of oxygen atoms of TiC_{X}O_{Y}N_{Z} in the sinter (substrate 7, 7′ for magnetic heads) to be in the range of 0.005 to 0.30. By controlling the number Y of oxygen atoms within this range, detachment of crystal grains can be reduced. In addition, since a reaction between oxygen and diamond of a diamond blade can be reduced during cutting, the value of chipping can be decreased. In particular, the number Y of oxygen atoms may be in the range of 0.02 to 0.12. In the case where the number Y of oxygen atoms is not less than 0.005, the capacity of TiC_{X}O_{Y}N_{Z} for containing oxygen can be kept with sufficient value. Consequently, the bonding strength with Al₂O₃ can be kept high, thereby reducing detachment of crystal grains. In the case where the number Y of oxygen atoms is not more than 0.30, oxygen and diamond of a diamond blade, which is used when the substrate for magnetic heads is cut into strips, less likely react with each other. Consequently, it is easy to cut the substrate, thus decreasing the value of chipping.

It is important to control the number Z of nitrogen atoms of TiC_{X}O_{Y}N_{Z} in the sinter (substrate 7, 7′ for magnetic heads) to be in the range of 0.002 to 0.20. By controlling the number Z of nitrogen atoms within this range, detachment of crystal grains can be reduced. In addition, since a reaction between nitrogen and diamond of a diamond blade can be reduced during cutting, the value of chipping can be decreased. In particular, the number Z of nitrogen atoms may be in the range of 0.005 to 0.07. In the case where the number Z of nitrogen atoms is not less than 0.002, grain growth of Al₂O₃ can be sufficiently reduced, and thus coarse Al₂O₃ crystal grains, which are readily detached, can be less likely formed in the sinter. In the case where the number Z of nitrogen atoms is not more than 0.2, nitrogen and diamond less likely react with each other when a diamond blade is used in cutting the substrate for magnetic heads into strips. Consequently, it is easy to cut the substrate, thus decreasing the value of chipping.

The sum of the minimum values of the numbers X, Y, and Z of the atoms in TiC_{X}O_{Y}N_{Z} is 0.507. In addition, since TiC_{X}O_{Y}N_{Z} has a structure in which some of carbon atoms in TiC are replaced with oxygen and nitrogen atoms, the maximum value of the sum of the numbers X, Y, and Z of the atoms is 1. Accordingly, the range of the sum (X+Y+Z) is inevitably 0.507 or more and 1 or less. In particular, the value of X+Y+Z is preferably close to 1 in order to make lattice points of TiC_{X}O_{Y}N_{Z} saturated with atoms. The value of X+Y+Z may be specifically, 0.85 or more. In this range, during producing the substrate for magnetic heads, oxidation due to the effect of the atmosphere can reduce.

The numbers X, Y, and Z of the atoms in TiC_{X}O_{Y}N_{Z} can be determined as follows.

First, the contents of Al and Ti are measured by fluorescent X-ray spectroscopy or inductively coupled plasma (ICP) emission spectroscopy, and the contents of C, O₂, and N₂ are measured with a carbon analyzer and an oxygen/nitrogen analyzer. Next, the measured Al is converted to the oxide thereof, and the O₂ content required for this conversion of the Al to the oxide is subtracted from the O₂ content measured with the oxygen/nitrogen analyzer to determine the O₂ content of TiC_{X}O_{Y}N_{Z}. Thus, the contents of respective elements in TiC_{X}O_{Y}N_{Z} can be obtained. The number of moles of each element is determined by dividing the content of the element by the atomic weight thereof. The proportion of the respective elements determined when the number of moles of Ti is assumed to be 1 corresponds to the numbers X, Y, and Z of the atoms.

An average crystal grain size (DT) of the TiC_{X}O_{Y}N_{Z} crystal grains in the sinter such as the substrate 7/97 for the magnetic head 2 may be less than about 0.25 μm. When the average crystal grain size of TiC_{X}O_{Y}N_{Z} crystal grains in the sinter is greater than zero and less than about 0.25 μm, abnormal grain growth of the Al₂O₃ crystal grains is reduced and detachment of the crystal grains in the sinter can be reduced. The average crystal grain size (DT) may be less than about 0.20 μm. In this case, machinability can be improved. On the other hand, from a standpoint that detachment of the crystal grains in the sinter is reduced, an average crystal grain size (DA) of the Al₂O₃ crystal grains in the sinter may be equal to or more than the average crystal grain size (DT) of the TiC_{X}O_{Y}N_{Z} crystal grains, and at most two times the average crystal grain size (DT) of the TiC_{X}O_{Y}N_{Z} crystal grains.

A maximum average crystal grain size of the TiC_{X}O_{Y}N_{Z} crystal grains may be about 0.75 μm or less. A maximum average crystal grain size of the Al₂O₃ crystal grains may be about 1.5 μm or less. In this case, the TiC_{X}O_{Y}N_{Z} crystal grains and the Al₂O₃ crystal grains consist of the grains having relatively small size, respectively. Therefore, when the flow path surface 23 is formed with method or method, flatness of the flow path surface 23 can be improved.

The average crystal grain sizes of the TiC_{X}O_{Y}N_{Z} crystal grains and the Al₂O₃ crystal grains in the sinter and a substantially maximum crystal grain size of the crystal grains can be determined by analyzing an image taken with a scanning electron microscope (SEM) using image processing software, for example but without limitation, Image-Pro Plus™, manufactured by Media Cybernetics, Inc., and the like.

A proportion R of a number of TiC_{X}O_{Y}N_{Z} crystal grains present on any straight line having a length of about 10 μm or more on a cut surface of the sinter to a total of the number of the TiC_{X}O_{Y}N_{Z} crystal grains and the number of Al₂O₃ crystal grains present on the straight line is about 55% or more and about 75% or less. When the proportion R is about 55% or more, abnormal grain growth of the Al₂O₃ crystal grains can be reduced by incorporating the TiC_{X}O_{Y}N_{Z} crystal grains. In addition, the TiC_{X}O_{Y}N_{Z} crystal grains having a higher hardness than the Al₂O₃ crystal grains are dispersed in the sinter, whereby the TiC_{X}O_{Y}N_{Z} crystal grains function as components that provide an anchoring effect to the Al₂O₃ crystal grains. Consequently, a bonding strength between the crystal grains is improved in the sinter. As a result, detachment of crystal grains can be reduced in a step of cutting the substrate 7/97 for a magnetic head 2 into strips using a slicing machine or a dicing saw, and a step of forming a flow path surface 75 (23) by an ion-milling method or a reactive ion etching method. Furthermore, when the proportion R is about 55% or more, the sinter can have a high electrical conductivity. Therefore, when the magnetic head 2 is charged, the electric charges can be substantially immediately removed. On the other hand, when the proportion R is about 75% or less, the sinterability of the Al₂O₃ is improved in the sintering step, and thus the sinter can be densified.

According to an embodiment, the length of an arbitrary straight line on a cut surface of a sinter for determining the ratio R is about 10 μm or more. The average crystal grain size of crystal grains in the sinter is, for example but without limitation, about 0.25 μm or less. Therefore, in the average crystal grain size in this range, with the length of the straight line to be 10 μm or more, the number of TiC_{X}O_{Y}N_{Z} crystal grains and the number of Al₂O₃ crystal grains can be determined with a high accuracy. An upper limit of a length of the arbitrary straight line may be about 100 μm or less to simplify measurement while sufficiently ensuring the accuracy of the measurement.

The proportion R can be determined by a procedure described below.

First, a surface 98 of the substrate 7/97 for a magnetic head 2 is polished using diamond abrasive grains to form a mirror-finished surface, and the surface 98 is then etched with phosphoric acid for about several tens of seconds. Next, an arbitrary position is selected on the etched surface using a scanning electron microscope (SEM), and an image (SEM image) is taken at a magnification in the range of about 10,000 to about 13,000. The obtained SEM image is processed using, an image processing software, for example but without limitation, JTrim, and the like. Specifically, the SEM image is converted to gray scale, and fine noise is removed with a filter, thus obtaining an image, the contrast of which is more emphasized as compared with the SEM image.

Next, a process of emphasizing the brightness (lightness and darkness) is performed on the image, the contrast of which is emphasized, and binarization is performed. In the image obtained by this process, an area occupied by the crystal grains is displayed as number of pixels. The binarization refers to a process that converts the density of an image to two values of white and black. For example, the Al₂O₃ crystal grains are processed as black and the TiC_{X}O_{Y}N_{Z} crystal grains are processed as white.

Next, the displayed number of pixels are converted to the area occupied by the TiC_{X}O_{Y}N_{Z} crystal grains and the area occupied by the Al₂O₃ crystal grains using, for example but without limitation, a software such as Gazou Kara Menseki produced by Teppei Akao, and the like. A total area occupied by these crystal grains may be about 100 μm². In this manner, an area of the TiC_{X}O_{Y}N_{Z} crystal grains and an area of the Al₂O₃ crystal grains in an area of about 100 μm² is calculated respectively. Next, each portion occupied by the calculated area of the TiC_{X}O_{Y}N_{Z} crystal grains and the calculated area of the Al₂O₃ crystal grains is considered as a square respectively, and a length of one side of the square is determined for the TiC_{X}O_{Y}N_{Z} crystal grains and the Al₂O₃ crystal grains respectively. By dividing a determined length of the one side by the average crystal grain size, a calculated number of the TiC_{X}O_{Y}N_{Z} crystal grains and a calculated number of the Al₂O₃ crystal grains can be determined. The calculated numbers of the TiC_{X}O_{Y}N_{Z} crystal grains and the calculated number of the Al₂O₃ crystal grains are divided by a total number of TiC_{X}O_{Y}N_{Z} crystal grains and the number of Al₂O₃ crystal grains (total number of grains) respectively. Whereby a proportion of the number of the TiC_{X}O_{Y}N_{Z} crystal grains to the total number of grains present on an arbitrary straight line having a length of about 10 μm and a proportion of the number of Al₂O₃ crystal grains to the total number of grains present on the arbitrary straight line having a length of about 10 μm can be determined. In this manner, it is possible to calculate the proportion R of the number of TiC_{X}O_{Y}N_{Z} crystal grains to the total of the number of TiC_{X}O_{Y}N_{Z} crystal grains and the number of Al₂O₃ crystal grains present on an arbitrary straight line having a length of about 10 μm or more. In a case where the proportion of the number of TiC_{X}O_{Y}N_{Z} crystal grains present on an arbitrary straight line having a length of about 10 μm or more and about 100 μm or less is determined, a total area occupied by the TiC_{X}O_{Y}N_{Z} crystal grains and the Al₂O₃ crystal grains is set to be in a range of about 100 to about 10,000 μm².

In addition, the sinter may have a flexural strength of about 800 MPa or more and a thermal conductivity of about 19 W/(m·k) or more.

In a case where the sinter has a flexural strength of about 800 MPa or more, even when the substrate 7/97 for a magnetic head 2 is divided into chips, formation of microcracks can be reduced. As a result, detachment of the crystal grains due to the formation of microcracks can be reduced. Accordingly, the magnetic head 2 comprising the substrate 7/97 can have good contact-start-stop (CSS) characteristics. Similarly, the detachment of the crystal grains due to formation of microcracks can also be reduced in a compact slider, such as but without limitation, a femto-slider, an ato-slider, and the like.

In a case where the sinter has a thermal conductivity of about 19 W/(m·k) or more, heat generated from the electromagnetic conversion element 20 can be immediately dissipated to the slider 21. Therefore, in the magnetic head 2 comprising such a substrate 7/97 having good thermal conductivity, thermal destruction of records stored in a recording medium can be reduced.

The flexural strength of the sinter can be evaluated in terms of the three-point bending strength, for example but without limitation, in accordance with the JIS R 1601-1995 testing method. However, in a case where it may not be possible to cut a specimen specified in this JIS standard from the substrate 7/97 for a magnetic head 2, the thickness T of the substrate 7/97 may be used as a thickness of the specimen. A thermal conductivity of the sinter can be measured, for example but without limitation, in accordance with the JIS R 1611-1997 testing method.

Such a substrate 7/97 for a magnetic head 2 is prepared by, for example but without limitation, pressure sintering using granules obtained by mixing, pulverizing, granulating a material powder, and the like.

A mixture containing an Al₂O₃ powder in an amount of about 60% by mass or more and about 70% by mass or less, a TiC_{X}O_{Y}N_{Z} powder in an amount of about 30% by mass or more and about 40% by mass or less is used as the material powder. In the TiC_{X}O_{Y}N_{Z} powder, X, Y and Z satisfy the relationships 0.5≦X≦0.993, 0.005≦Y≦0.3, 0≦Z≦0.2, and 0.507≦X+Y+Z≦1.

In order to promote sintering to further densify the resulting sinter, at least one of a Yb₂O₃ powder, a Y₂O₃ powder, and MgO powder may be added to the material powder in an amount of about 0.1% by mass or more and about 0.6% by mass or less. The material powder is mixed with, for example, a ball mill, a vibration mill, a colloid mill, an attritor, or a high-speed mixer. For example, beads for pulverization having a diameter of about 2.8 mm or less are used for pulverizing the material powder. Consequently, the average particle diameter of the material powder can be controlled to be greater than zero and less than about 0.5 μm, and the average crystal grain size of the resulting sinter can be controlled to be less than about 0.25 μm. In the case where the average particle diameter of the material powder is greater than zero and less than about 0.4 μm, the average crystal grain size of the resulting sinter can be easily controlled to be less than about 0.2 μm.

The average particle diameter of the material powder after pulverization can be measured by a liquid-phase precipitation method, a centrifugal sedimentation light transmission method, a laser diffraction scattering method, a laser Doppler method, or the like.

Molding aids such as a binder and a dispersant are added to the pulverized material powder, and the resulting mixture is uniformly mixed. Subsequently, granulation can be performed using a known granulator to obtain granules. Examples of the granulator that can be used comprise a tumbling granulator, a spray dryer, and a compression granulator. The granules are formed so as to have an average particle diameter of, for example, about 100 μm or less. By controlling the average particle diameter of the granules to be about 100 μm or less, aggregation of the pulverized raw material and separation of the composition constituting the raw material can be reduced.

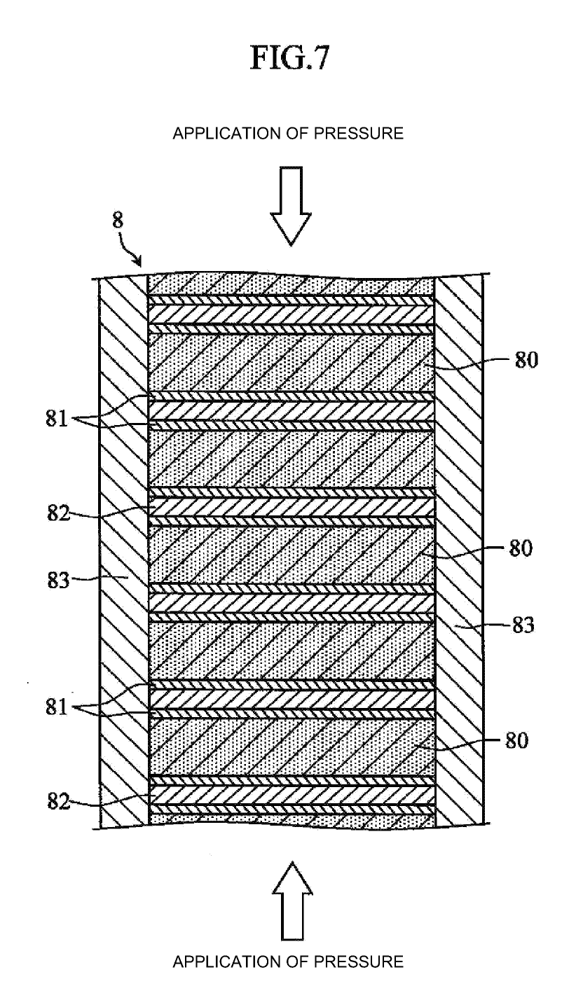

Pressure sintering is conducted, for example, as follows. Compacts prepared by compacting the granules so as to have a desired shape are placed in a pressure-sintering apparatus. Specifically, as shown in FIG. 7, compacts 80 are arranged, for example, in a pressure-sintering apparatus 8 so as to be stacked with graphite spacers 82 therebetween. Carbonaceous releasing components 81 are disposed between each main surface of the compacts 80 and each spacer 82. In the pressure-sintering apparatus 8, a shield 83 containing a carbonaceous material is disposed around the compacts 80.

By arranging the shield 83 containing the carbonaceous material around the compacts 80 in the pressure sintering, an alteration from TiC_{X}O_{Y}N_{Z} particles to TiO, TiO₂ particles and like that can be reduced. Consequently, substrates 7/97 having good machinability can be obtained.

After the compacts 80 are arranged in the pressure-sintering apparatus 8, pressure sintering is conducted in an atmosphere of, for example, argon, helium, neon, nitrogen, or a vacuum at a temperature in the range of about 1,400° C. to about 1,700° C. while a pressure of about 30 MPa or more is applied. Accordingly, the disc-shaped substrate 97 shown in FIG. 6B can be obtained. The substrate 7 shown in FIG. 6A can be formed by cutting a part of the disc-shaped substrate 97 shown in FIG. 6B with a dicing saw.

When the pressure-sintering temperature is controlled to be in the range of about 1,400° C. to about 1,700° C., sufficient sintering can be conducted, and excessive growth of the TiC_{X}O_{Y}N_{Z} crystal powder can be reduced while TiC_{X}O_{Y}N_{Z} crystal grains are appropriately dispersed. Accordingly, the crystal structure of the resulting sinter gets closer homogeneous, and thus the function of TiC_{X}O_{Y}N_{Z} can be sufficiently achieved. In addition, when the pressure applied during the sintering is controlled to be about 30 MPa or more, densification of the sinter is accelerated, and thus a preferable strength of the substrate 7/97 for a magnetic head can be obtained.

After the pressure sintering, hot isostatic pressing (HIP) sintering may be optionally conducted. By conducting hot isostatic pressing (HIP) sintering, the flexural strength of the sinter can be easily increased to about 800 MPa or more.

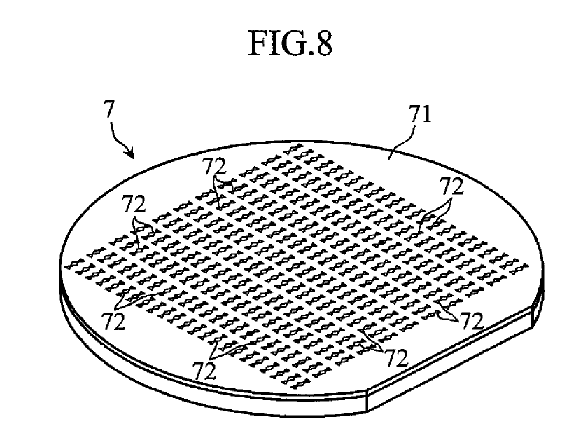

As shown in FIG. 8, after a completion of the sintering, electromagnetic conversion elements 72 are formed. Specifically, an insulating film 71 composed of amorphous alumina is deposited on the substrate 7/97 for a magnetic head 2 by a sputtering method, and the electromagnetic conversion elements 72 are then formed on the insulating film 71. The electromagnetic conversion elements 72 may be, for example and without limitation, MR elements, GMR elements, TMR elements, anisotropic magnetoresistive (AMR) elements, and the like.

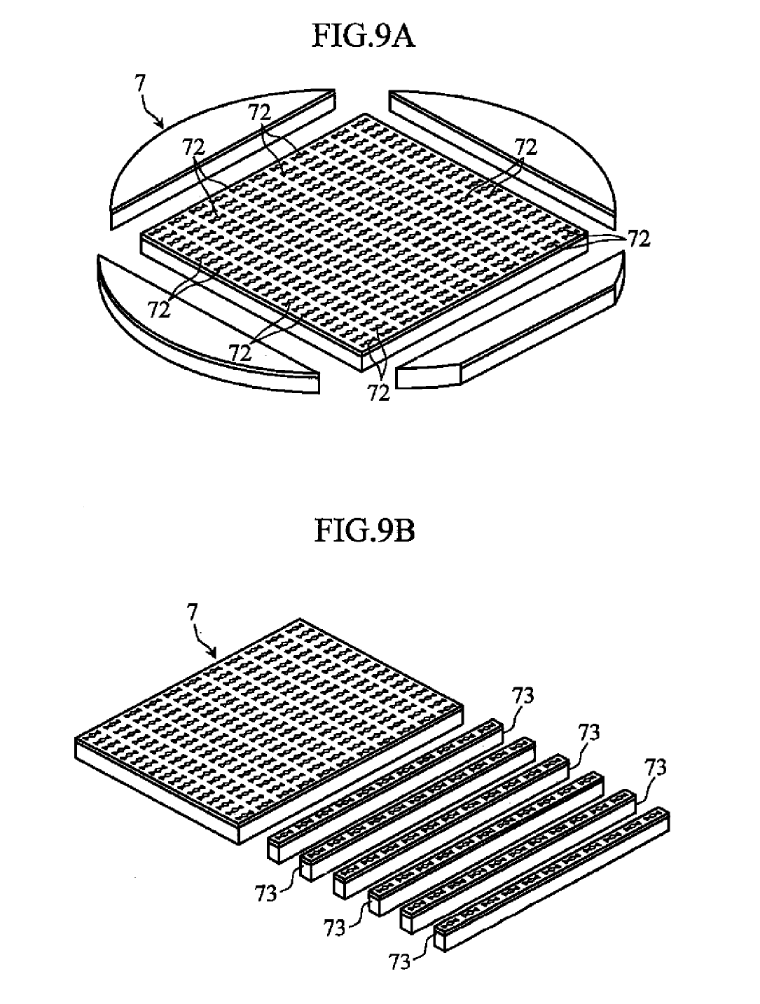

Next, as shown in FIG. 9A, unnecessary portions of the substrate 7/97 are cut from the periphery of an area on which the electromagnetic conversion elements 72 are mounted so that the substrate 7/97 has a quadrangular shape. Furthermore, as shown in FIG. 9B, the quadrangular substrate 7/97 is cut along the rows of the electromagnetic conversion elements 72 to prepare strips 73. The substrate 7/97 for a magnetic head 2 can be cut, for example but without limitation, with a slicing machine, a dicing saw, or the like.

Next, a surface of each of the strips 73 which represents the surface functioning as the flying surface 22 of a slider 21 in FIG. 5, is polished to form a mirror-finished surface. This polishing can be conducted by using, for example but without limitation, a lapping machine, and the like.

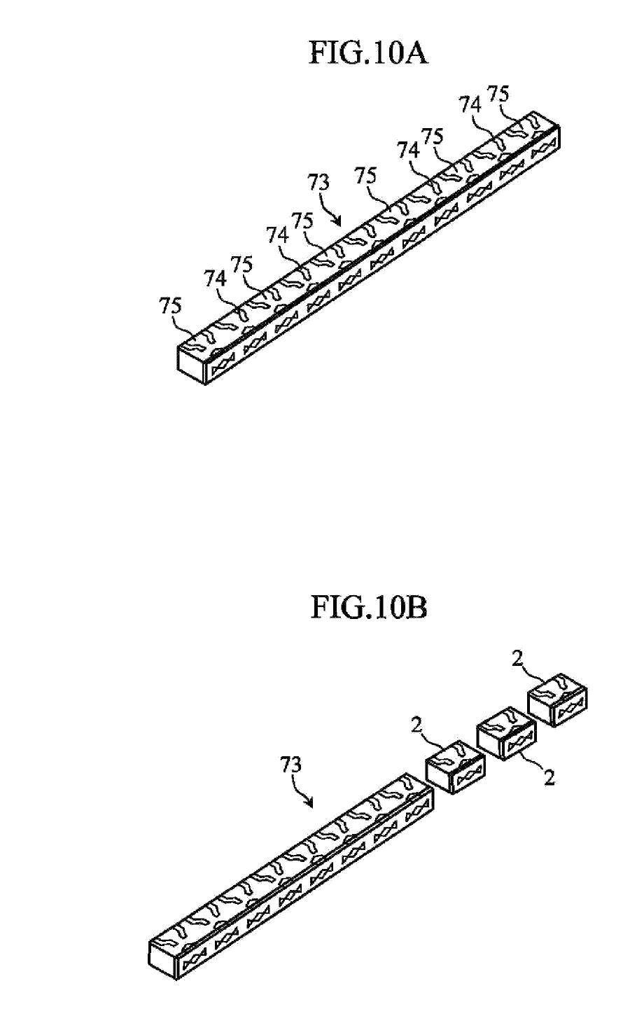

Next, as shown in FIG. 10A, flow path surfaces 75 (recesses 75) are formed on a polished surface 74 of each strip 73. As mentioned above, each of the recesses 75 functions as the flow path surface 23 configured to pass the air for making the magnetic head 2 fly. Remaining mirror-finished portions of the polished surface 74 (i.e., portions where the recesses 75 are not formed) function as the flying surface 22 (FIG. 5) of the magnetic head 2 facing a magnetic recording medium.

The recesses 75 are formed so as to have a desired shape, depth, and surface roughness by, for example but without limitation, an ion-milling method, a reactive ion etching method, or the like. The depth of each of the recesses 75 is controlled to be, for example, about 1.5 μm or more and about 2.5 μm or less with respect to the polished surface 74 (flying surface 22 in FIG. 5). The arithmetic mean roughness (Ra) on the surface of each of the recesses 75 is controlled to be, for example, greater than zero and less than about 15 nm. When the recess 75 has such a surface roughness, the smoothness of the flow path surface 23 (FIG. 5) of the magnetic head 2 is improved, thereby appropriately controlling the air flow. Consequently, the flying characteristics of the magnetic head 2 can be stabilized.

In order to control the arithmetic mean roughness (Ra) of the recess 75 to be about 15 nm or less, processing conditions are appropriately selected in the ion-milling method or the reactive ion etching method. For example, when the recess 75 is formed by an ion-milling method, the strip 73 may be processed using Ar ions at an accelerating voltage of about 600 V and a milling rate of about 18 nm/min for about 75 to about 125 minutes. On the other hand, when the recess 75 is formed by a reactive ion etching method, the strip 73 may be processed using Ar gas and CF₄ gas in a mixed gas atmosphere in which the flow rate of the Ar gas is about 3.4×10⁻² Pa·m³/s and a flow rate of the CF₄ gas is about 1.7×10⁻² Pa·m³/s at a pressure of this mixed gas of about 0.4 Pa.

Lastly, as shown in FIG. 10B, the strip 73 comprising the recesses 75 thereon is cut. In this manner, the chip-like magnetic heads 2 shown in FIG. 5 is produced.

The above-mentioned ratio R of the substrate 7/97 for the magnetic head 2 and the slider 21 of the magnetic head 2, which are produced by the method described above, is about 55% or more and about 75% or less. Accordingly, when the substrate 7/97 for a magnetic head is cut into strips with a slicing machine or a dicing saw or when the recesses 75 (flow path surfaces 23) are formed by an ion-milling method or a reactive ion etching method, detachment of the crystal grains can be reduced.

According to the magnetic head 2 obtained from the substrate 7/97 for a magnetic head 2, detachment of the crystal grains from the flow path surface 23 can be reduced when a hard disk, which is a recording medium, contacts the magnetic head 2 because of unexpected vibrations or impacts. Consequently, possible degradation of the characteristics due to scratches on the recording medium formed by the detached crystal grains can be reduced. That is, the magnetic head 2 can have good performance in read/write.

Examples of the present disclosure are described below.

### Example 1

In this Example, as shown in Table 1, 31 types of substrates (sample Nos. 1 to 31) for magnetic heads such as the magnetic head 2 were prepared. Proportions of Al₂O₃ and TiC_{X}O_{Y}N_{Z} in terms of mass, an electrical conductivity, density, the proportion of the number of TiC_{X}O_{Y}N_{Z} crystal grains, machinability and hardness of each of the substrates were examined.

TABLE 1

| | Average | Particle | | | | | | |
|---|---|---|---|---|---|---|---|---|
| | particle | diameter of | | | The | The | The | Sum of the |
| | diameter | pulverized | | | number | number | number | numbers of |
| Sample | of beads | raw material | Al₂O₃ | TiC_{X}O_{Y}N_{Z} | X of | Y of | Z of | atoms |
| No. | (μm) | (μm) | (mass %) | (mass %) | atom | atom | atom | (X + Y + Z) |
| 1 | 0.3 | 0.5 | 55 | 45 | 0.85 | 0.145 | 0.005 | 1 |
| 2 | 0.5 | 0.7 | 60 | 40 | 0.85 | 0.145 | 0.005 | 1 |
| 3 | 0.3 | 0.5 | 60 | 40 | 0.85 | 0.145 | 0.005 | 1 |
| 4 | 0.2 | 0.3 | 60 | 40 | 0.85 | 0.145 | 0.005 | 1 |
| 5 | 0.5 | 0.7 | 64 | 36 | 0.85 | 0.145 | 0.005 | 1 |
| 6 | 0.3 | 0.5 | 64 | 36 | 0.35 | 0.145 | 0.005 | 0.5 |
| 7 | 0.3 | 0.5 | 64 | 36 | 0.5 | 0.145 | 0.005 | 0.65 |
| 8 | 0.3 | 0.5 | 64 | 36 | 0.65 | 0.145 | 0.005 | 0.8 |
| 9 | 0.3 | 0.5 | 64 | 36 | 0.80 | 0.145 | 0.005 | 0.95 |
| 10 | 0.3 | 0.5 | 64 | 36 | 0.993 | 0.005 | 0.002 | 1 |
| 11 | 0.3 | 0.5 | 64 | 36 | 1 | 0 | 0 | 1 |
| 12 | 0.3 | 0.5 | 64 | 36 | 0.5 | 0.002 | 0.001 | 0.503 |
| 13 | 0.3 | 0.5 | 64 | 36 | 0.5 | 0.005 | 0.002 | 0.507 |
| 14 | 0.3 | 0.5 | 64 | 36 | 0.5 | 0.005 | 0.01 | 0.515 |
| 15 | 0.3 | 0.5 | 64 | 36 | 0.5 | 0.1 | 0.01 | 0.61 |
| 16 | 0.3 | 0.5 | 64 | 36 | 0.5 | 0.2 | 0.01 | 0.71 |
| 17 | 0.3 | 0.5 | 64 | 36 | 0.5 | 0.3 | 0.01 | 0.81 |
| 18 | 0.3 | 0.5 | 64 | 36 | 0.5 | 0.4 | 0.01 | 0.91 |
| 19 | 0.3 | 0.5 | 64 | 36 | 0.55 | 0.145 | 0.001 | 0.696 |
| 20 | 0.3 | 0.5 | 64 | 36 | 0.55 | 0.145 | 0.002 | 0.697 |
| 21 | 0.3 | 0.5 | 64 | 36 | 0.55 | 0.145 | 0.1 | 0.795 |
| 22 | 0.3 | 0.5 | 64 | 36 | 0.55 | 0.145 | 0.2 | 0.895 |
| 23 | 0.3 | 0.5 | 64 | 36 | 0.55 | 0.145 | 0.3 | 0.995 |
| 24 | 0.2 | 0.3 | 64 | 36 | 0.5 | 0.145 | 0.005 | 0.65 |
| 25 | 0.2 | 0.2 | 64 | 36 | 0.5 | 0.145 | 0.005 | 0.65 |
| 26 | 0.2 | 0.1 | 64 | 36 | 0.5 | 0.145 | 0.005 | 0.65 |
| 27 | 0.3 | 0.5 | 70 | 30 | 0.5 | 0.145 | 0.005 | 0.65 |
| 28 | 0.2 | 0.3 | 70 | 30 | 0.5 | 0.145 | 0.005 | 0.65 |
| 29 | 0.3 | 0.5 | 75 | 25 | 0.5 | 0.145 | 0.005 | 0.65 |
| 30 | 0.3 | 0.3 | 75 | 25 | 0.5 | 0.145 | 0.005 | 0.65 |
| 31 | 0.2 | 0.08 | 64 | 36 | 0.5 | 0.145 | 0.005 | 0.65 |

Each of the substrates for magnetic heads was produced by preparing a predetermined slurry, forming a compact using the slurry, and then conducting pressure sintering.

The slurry was prepared by charging predetermined amounts of an Al₂O₃ powder, a TiC_{X}O_{Y}N_{Z} powder, an Yb₂O₃ powder, a binder for compaction, and a dispersant in a bead mill. Average particle diameters of beads for pulverization used in this step are shown in Table 1. The particle diameter of the pulverized raw material in the slurry was measured as an average particle diameter using a centrifugal sedimentation light transmission method specified in JIS Z 8823-2: 2004. The measurement results of the particle diameters of the pulverized raw materials are shown in Table 1.

The slurry was formed into granules by a spray-drying method, and the granules were then compacted by dry pressure compaction to form the compacts.

As shown in FIG. 7, the resulting compacts were arranged on 14 stages for respective samples to be prepared, and pressure sintering was conducted in a vacuum atmosphere at a temperature of 1,600° C., at a pressure of 40 MPa, at a temperature increase rate of 10° C./min, and a hold time of 60 minutes. Subsequently, hot isostatic pressing (HIP) sintering was conducted to prepare substrates for magnetic heads of sample Nos. 1 to 31 each having a diameter of 152.4 mm and a thickness of 3 mm.

The mass ratio of Al₂O₃ and TiC_{X}O_{Y}N_{Z} in each of the substrates for magnetic heads was measured by the following procedure. First, the contents of Al and Ti were measured with a fluorescent X-ray analyzer (Rigaku ZSX100e, manufactured by Rigaku Corporation). Separately, the contents of C, O₂, and N₂ were measured with a carbon analyzer (EMTA-511, manufactured by HORIBA, Ltd.) and an oxygen/nitrogen analyzer (EMGA-650FA, manufactured by HORIBA, Ltd.). The mass percent of Al₂O₃ was determined by converting Al to the oxide thereof. The O₂ content of TiC_{X}O_{Y}N_{Z} was determined by subtracting the O₂ content required for this conversion of Al to the oxide from the O₂ content measured with the oxygen/nitrogen analyzer. The mass percent of TiC_{X}O_{Y}N_{Z} was determined by adding the contents of C, N₂, and Ti to the O₂ content of TiC_{X}O_{Y}N_{Z}. The measurement results of the mass proportion of Al₂O₃ and TiC_{X}O_{Y}N_{Z} are shown in Table 1.

Notably, the mass ratio of Yb₂O₃ was very low, namely, less than 1% by mass in the samples, therefore the mass ratio of Yb₂O₃ is not shown in Table 1.

The proportion of the number of TiC_{X}O_{Y}N_{Z} crystal grains was evaluated by the following procedure as a proportion R of the number of TiC_{X}O_{Y}N_{Z} crystal grains (first value) to the total of the number of TiC_{X}O_{Y}N_{Z} crystal grains and the number of Al₂O₃ crystal grains (second value) present on an arbitrary straight line having a length of 10 μm or more on a cut surface of each substrate for a magnetic head.

First, a surface of a substrate for a magnetic head was polished with diamond abrasive grains to form a mirror-finished surface, and the surface was then etched with phosphoric acid for about several tens of seconds. Next, an arbitrary position on the etched surface was selected using a scanning electron microscope (SEM), and an SEM image was taken at a magnification of 13,000. The area of crystal grains of the TiC_{X}O_{Y}N_{Z} and the area of the crystal grains of Al₂O₃ were determined from the obtained SEM image using software such as the JTrim and the Gazou Kara Menseki as mentioned above. Each of the areas of the crystal grains was considered as a square. By dividing a side of the square by the average crystal grain size, the number of the TiC_{X}O_{Y}N_{Z} crystal grains and the number of the Al₂O₃ crystal grains present on the arbitrary straight line having a length of 10 μm were determined. On the basis of the measurement results of the numbers of crystal grains, the proportion R of the number of the TiC_{X}O_{Y}N_{Z} crystal grains (first value) to the total of the number of TiC_{X}O_{Y}N_{Z} crystal grains and the number of Al₂O₃ crystal grains (second value) present on the arbitrary straight line having a length of 10 μm was determined. The measurement results of the number of the TiC_{X}O_{Y}N_{Z} crystal grains, the number of Al₂O₃ crystal grains, and the proportion R of the number of TiC_{X}O_{Y}N_{Z} crystal grains are shown in Table 2.

The numbers X, Y, and Z of the atoms of TiC_{X}O_{Y}N_{Z} of each sample were determined as follows. The number of moles of each element was determined by dividing the content of the element used in determining the above-mentioned mass percent of TiC_{X}O_{Y}N_{Z} by the atomic weight thereof, and the proportion of the respective elements determined when the number of moles of Ti was assumed to be 1 was then calculated. The calculated values are the numbers X, Y, and Z of the atoms. The calculation results are shown in Table 1.

The electrical conductivity of each substrate for a magnetic head was evaluated in terms of the volume resistivity in accordance with the JIS C 2141-1992 testing standard. The measurement results of the volume resistivity are shown in Table 2. When the volume resistivity of a substrate for a magnetic head is 4×10⁻¹ Ω·m or less, electric charges generated on an electromagnetic conversion element can be immediately removed in a magnetic head prepared from such a substrate. Accordingly, when the volume resistivity of a substrate for a magnetic head was 4×10⁻¹ Ω·m or less, the substrate was evaluated as acceptable. When the volume resistivity of a substrate for a magnetic head exceeded 4×10⁻¹ Ω·m, the substrate was evaluated as unacceptable.

Machinability of each substrate for a magnetic head was evaluated in terms of a substantially maximum value of chipping in the strips. The substantially maximum value of the chipping was measured as follows. Ten strips were cut out from a single substrate for a magnetic head, and a cut surface of each of the strips was then observed with a metallurgical microscope at a magnification of 400. The strips were cut out using a slicing machine provided with a diamond blade so as to have a length of 70 mm, a width of 3 mm, and a thickness of 2 mm.

A diamond blade SD1200 was used. During the cutting of the substrate for a magnetic head, the number of revolutions of the diamond blade was 10,000 rpm, the feed speed was 100 mm/min, and the amount of cutting per operation was 2 mm.

Measurement results of the substantially maximum value of chipping are shown in Table 2. When the substantially maximum value of chipping in the strips is less than 8 μm, variation in the flying height of a magnetic head can be decreased. Accordingly, when the substantially maximum value of chipping in the strips was 8 μm or more, the strips were evaluated as unacceptable. When the substantially maximum value of chipping was less than 8 μm, the strips were evaluated as acceptable.

The hardness of each substrate for magnetic heads was evaluated in terms of Vickers hardness. The Vickers hardness was measured in accordance with JIS R 1610-2003. The measured values of the Vickers hardness are shown in Table 2.

TABLE 2

| | | The number (B) of | Proportion of the | | | |
|---|---|---|---|---|---|---|
| | The number (A) of | TiC_{X}O_{Y}N_{Z} crystal | number of | | Maximum | Vickers |
| | Al₂O₃ crystal grains | grains | TiC_{X}O_{Y}N_{Z}crystal | Volume | value of | hardness |
| Sample | (on straight line of | (on straight line of | grains (%) | resistivity | chipping | Hv |
| No. | 10 μm) | 10 μm) | (B/(A + B) × 100) | (Ω · m) | (μm) | (GPa) |
| 1 | 10 | 9 | 47 | 4 × 10⁻² | 12 | 20 |
| 2 | 5 | 5 | 50 | 9 × 10⁻² | 10 | 20 |
| 3 | 9 | 8 | 47 | 7 × 10⁻² | 8 | 20 |
| 4 | 14 | 17 | 55 | 5 × 10⁻² | 3 | 20 |
| 5 | 5 | 4 | 44 | 1 × 10⁻¹ | 9 | 20 |
| 6 | 8 | 10 | 56 | 1 × 10⁻¹ | 6 | 17 |
| 7 | 9 | 10 | 56 | 1 × 10⁻¹ | 5 | 19 |
| 8 | 8 | 11 | 58 | 1 × 10⁻¹ | 6 | 19 |
| 9 | 8 | 10 | 56 | 1 × 10⁻¹ | 5 | 20 |
| 10 | 8 | 11 | 58 | 1 × 10⁻¹ | 6 | 20 |
| 11 | 8 | 10 | 56 | 1 × 10⁻¹ | 9 | 20 |
| 12 | 9 | 11 | 55 | 1 × 10⁻¹ | 9 | 19 |
| 13 | 8 | 10 | 56 | 1 × 10⁻¹ | 6 | 19 |
| 14 | 8 | 10 | 56 | 1 × 10⁻¹ | 5 | 19 |
| 15 | 9 | 11 | 55 | 1 × 10⁻¹ | 5 | 19 |
| 16 | 8 | 11 | 58 | 1 × 10⁻¹ | 6 | 19 |
| 17 | 8 | 10 | 56 | 1 × 10⁻¹ | 5 | 19 |
| 18 | 8 | 11 | 58 | 1 × 10⁻¹ | 9 | 19 |
| 19 | 8 | 10 | 56 | 1 × 10⁻¹ | 5 | 19 |
| 20 | 9 | 11 | 55 | 1 × 10⁻¹ | 5 | 19 |
| 21 | 8 | 10 | 56 | 1 × 10⁻¹ | 6 | 19 |
| 22 | 8 | 11 | 58 | 1 × 10⁻¹ | 6 | 19 |
| 23 | 8 | 10 | 56 | 1 × 10⁻¹ | 9 | 19 |
| 24 | 15 | 20 | 57 | 1 × 10⁻¹ | 4 | 19 |
| 25 | 15 | 31 | 67 | 1 × 10⁻¹ | 3 | 19 |
| 26 | 13 | 38 | 75 | 1 × 10⁻¹ | 2 | 19 |
| 27 | 7 | 9 | 56 | 4 × 10⁻¹ | 6 | 19 |
| 28 | 12 | 16 | 57 | 3 × 10⁻¹ | 5 | 19 |
| 29 | 7 | 6 | 46 | 8 × 10⁻¹ | 9 | 19 |
| 30 | 11 | 13 | 54 | 6 × 10⁻¹ | 8 | 19 |
| 31 | 12 | 38 | 76 | 1 × 10⁻¹ | 9 | 19 |

As shown in Table 2, in sample Nos. 1, 2, 3, 5, 11, 12, 18, 23, and 31, the maximum value of chipping was large; specifically, 8 μm or more.

The reasons for this are believed to be as follows. In sample No. 1, since the proportion of TiC_{X}O_{Y}N_{Z} exceeded 40 mass percent, pores formed inside the sample in the sintering step affected the maximum value of chipping. In addition, since the proportion of the number of TiC_{X}O_{Y}N_{Z} crystal grains was less than 55%, Al₂O₃ crystal grains that had been abnormally grown during firing were detached when the sample was cut into strips.

In sample Nos. 2, 3, and 5, since the proportion of the number of TiC_{X}O_{Y}N_{Z} crystal grains was less than 55%, Al₂O₃ crystal grains that had been abnormally grown during firing were detached when the sample was cut into strips.

In sample No. 11, since the number X of carbon atoms in TiC_{X}O_{Y}N_{Z} exceeded 0.993 and each of the number of oxygen atoms and the number of nitrogen atoms was zero (TiC), grain growth of Al₂O₃ could not be sufficiently suppressed. Accordingly, abnormal grain growth of Al₂O₃ occurred and thus coarse Al₂O₃ crystal grains, which are readily detached, were present. Furthermore, the bonding strength with Al₂O₃ was also low. As a result, detachment of crystal grains occurred, resulting in the large maximum value of chipping.

In sample No. 12, the number Y of oxygen atoms in TiC_{X}O_{Y}N_{Z} was less than 0.005 and the number Z of nitrogen atoms was less than 0.002. Accordingly, grain growth of Al₂O₃ could not be sufficiently suppressed, and the bonding strength between TiC_{X}O_{Y}N_{Z} and Al₂O₃ decreased.

In sample No. 18, the number Y of oxygen atoms in TiC_{X}O_{Y}N_{Z} exceeded 0.30. In sample No. 23, the number Z of nitrogen atoms in TiC_{X}O_{Y}N_{Z} exceeded 0.20. Accordingly, oxygen and nitrogen readily reacted with diamond of a diamond blade used for cutting, and it was difficult to cut these samples.

In sample No. 31, since the proportion of the number of TiC_{X}O_{Y}N_{Z} crystal grains was higher than 75%, sintering of Al₂O₃ was inhibited in the sintering step and densification did not sufficiently occur. As a result, Al₂O₃ crystal grains were detached from the periphery of pores that were present in the sample during cutting with the slicing machine.

Sample No. 6 had a low Vickers hardness. The reason for this is believed to be as follows. Since the number X of carbon atoms in TiC_{X}O_{Y}N_{Z} was less than 0.5, the hardness of TiC_{X}O_{Y}N_{Z} was low, and the Vickers hardness of the sample itself was also low.

Sample Nos. 29 and 30 exhibited high volume resistivity. It is believed that, in these samples, if electric charges are generated on an electromagnetic conversion element mounted on a magnetic head, the electric charges cannot be removed immediately. It is believed that this is because the proportion of TiC_{X}O_{Y}N_{Z} in the substrate for magnetic heads (sliders) was less than 30 mass percent.

In contrast, sample Nos. 4, 7 to 10, 13 to 17, 19 to 22, and 24 to 28 exhibited high electrical conductivity and machinability, and the maximum value of chipping of these samples was small. These samples are common in that the proportion of TiC_{X}O_{Y}N_{Z} is in the range of 30 to 40 mass percent; the numbers X, Y, and Z of atoms in TiC_{X}O_{Y}N_{Z} satisfy the relationships 0.5≦X≦0.993, 0.005≦Y≦0.30, 0.002≦Z≦0.20, and 0.507≦X+Y+Z≦1; and the proportion of the number of TiC_{X}O_{Y}N_{Z} crystal grains present on any straight line having a length of 10 μm or more on a section of each sample is in the range of 55% to 75%.

These samples contained the TiC_{X}O_{Y}N_{Z} in an amount of 30% by mass or more and 40% by mass or less. Accordingly, both the electrical conductivity and machinability were improved. Furthermore, in these samples, the proportion of the number of TiC_{X}O_{Y}N_{Z} crystal grains presents on any straight having a length of 10 μm or more on a section of each sample is in the range of 55 to 75 and the numbers X, Y, and Z of atoms in TiC_{X}O_{Y}N_{Z} satisfy the relationships 0.5≦X≦0.993, 0.005≦Y≦0.30, 0.002≦Z≦0.20, and 0.507≦X+Y+Z≦1. Accordingly, these samples had high densities and thus were densified. As a result, the large maximum value of chipping was reduced.

### Example 2

In this Example, the relationship between the average crystal grain size of the TiC_{X}O_{Y}N_{Z} crystal grains and machinability was examined with respect to substrates for magnetic heads.

The substrates for magnetic heads were prepared under conditions substantially the same as those used in Example 1. However, in this Example, five types of slurry were prepared using a raw material of sample No. 25 (Tables 1 and 2) used in Example 1 by varying the pulverization time as shown in Table 3 below, and substrates (sample Nos. 32 to 36) for magnetic heads were prepared from these slurries.

The average crystal grain size of the TiC_{X}O_{Y}N_{Z} crystal grains of each substrate for a magnetic head was determined by analyzing an image of a range of 5 μm×8 μm taken with a scanning electron microscope (SEM) at a magnification of 13,000 using image processing software (e.g., Image-Pro PIus™ manufactured by Media Cybernetics, Inc.). The measurement results of the average crystal grain size are shown in Table 3 below.

Machinability of each substrate for the magnetic head was evaluated in terms of the substantially maximum value of chipping in strips by a method substantially the same as the method used in Example 1. A diamond blade having the same specification as that in Example 1 was used, but the feed speed of the diamond blade was set to 140 mm/min so that the machining condition was severer than that in Example 1. As for the substantially maximum value of chipping, a chipping having the largest dimension in the longitudinal direction on a cut surface of a strip was selected, and the value of the selected chipping was shown in Table 3.

TABLE 3

| | | | Maximum value |
|---|---|---|---|
| | | Average crystal grain | of chipping |
| | Pulverization | size of TiC_{X}O_{Y}N_{Z} | generated on |
| | time | crystal grains | section |
| Sample No. | (min) | (μm) | (μm) |
| 32 | 30 | 0.40 | 10 |
| 33 | 50 | 0.30 | 8 |
| 34 | 60 | 0.24 | 5 |
| 35 | 70 | 0.20 | 4 |
| 36 | 80 | 0.15 | 3 |
| 43 | 72 | 0.19 | 3 |
| 44 | 90 | 0.10 | 3 |

As shown in Table 3, in sample Nos. 34 to 36, even when the samples were machined under the severe condition, i.e., at a feed speed of the diamond blade of 140 mm/min, the substantially maximum value of chipping was small, namely, 5 μm. Thus, sample Nos. 34 to 36 reached the acceptable standard in terms of machinability. The average crystal grain size of the TiC_{X}O_{Y}N_{Z} crystal grains of sample Nos. 34 to 36 was less than 0.25 μm. Accordingly, when the average crystal grain size of the TiC_{X}O_{Y}N_{Z} crystal grains was less than 0.25 μm, good machinability was realized. Particularly, in sample Nos. 36, 43 and 44, the average crystal grain size of the TiC_{X}O_{Y}N_{Z} crystal grains was less than 0.20 μm. These samples have great machinability.

### Example 3

In this Example, the relationship between the flexural strength and machinability was examined with respect to substrates for magnetic heads.

The substrates for magnetic heads were prepared under conditions substantially the same as those used in Example 1. However, in this Example, each of the substrates (sample Nos. 37 to 39) for magnetic heads was prepared by pressure-sintering a compact composed of the raw material of sample No. 25 (Tables 1 and 2) used in Example 1, and then conducting hot isostatic pressing (HIP) sintering at a temperature shown in Table 4 below for one hour.

A flexural strength of each substrate for a magnetic head was measured as a three-point bending strength in accordance with the JIS R 1601-1995 measurement standard. The measurement results of the three-point bending strength are shown in Table 4 below.

Machinability of each substrate for the magnetic head was evaluated in terms of the substantially maximum value of chipping in strips by a method substantially the same as the method used in Example 1. A diamond blade having the same specification as that in Example 1 was used, but the feed speed of the diamond blade was set to 180 mm/min so that the machining condition was severer than the conditions in Examples 1 and 2. As for the maximum value of chipping, a chipping having the largest dimension in the longitudinal direction on a cut surface of a strip was selected, and the value of the selected chipping was shown in Table 4.

TABLE 4

| | Hot isostatic | | |
|---|---|---|---|
| | pressing | | |
| | sintering | Three-point | Maximum value |
| | temperature | bending strength | of chipping |
| Sample No. | (° C.) | (MPa) | (μm) |
| 37 | 1,500 | 720 | 9 |
| 38 | 1,550 | 800 | 4 |
| 39 | 1,600 | 840 | 3 |

As shown in Table 4, in sample Nos. 38 and 39, even when the machining condition was severe, that is, even when the feed speed of the diamond blade was 180 mm/min, the substantially maximum value of chipping generated was small and detachment of the crystal grains did not tend to occur because the samples had high three-point bending strengths of 800 MPa or more.

### Example 4

In this Example, the relationship between the arithmetic mean roughness (Ra) of a recess (flow path surface) and variation in the flying height of a magnetic head was examined with respect to magnetic heads.

Each of the magnetic heads was prepared using a substrate for a magnetic head under the same conditions as those of sample No. 25 used in Examples 1 and 2. The substrate for a magnetic head was cut into strips, and a cut surface of each of the strips was polished so as to have a mirror-finished surface. The recess (flow path surface) was then formed by removing a part of the mirror-finished surface using an ion-milling apparatus (e.g., Model AP-MIED manufactured by JEOL Ltd.). As for an ion-milling process, Ar ions were used, the accelerating voltage was set to 600 V, and the milling process was conducted at different milling rates shown in Table 5 below until the depth of a recess reached 0.2 μm, whereby recesses having different surface roughnesses were formed. The strips after trimming were cut with a diamond blade to prepare magnetic heads (sample Nos. 40 to 42). A femto-slider having a length of 0.85 mm, a width of 0.7 mm, and a thickness of 0.23 mm was used as a slider provided on each of the magnetic heads.

The arithmetic mean roughness (Ra) of the recess (flow path surface) was measured using an atomic force microscope in accordance with JIS B 0601-2001. However, the measurement length was set to 10 μm.

The flying height (flying amount) of each of the magnetic heads was measured with a flying height tester. In this measurement with the flying height tester, the magnetic head was made to fly above a transparent glass substrate not having a magnetic recording layer thereon while rotating the glass substrate. The flying height of the magnetic head was measured ten times in total, every five seconds, at a peripheral velocity of the glass substrate of 12.44 mm/s. The measurement results of the flying height of the magnetic heads are shown in Table 5 in terms of the average of the ten times measurement and the standard deviation.

TABLE 5

| | | | Flying height | |
|---|---|---|---|---|
| | | Arithmetic mean roughness | | Standard |
| Sample | Milling rate | (Ra) of flow path surface | Average | deviation |
| No. | (nm/min) | (nm) | (nm) | (nm) |
| 40 | 15 | 12 | 9 | 0.04 |
| 41 | 20 | 15 | 10 | 0.05 |
| 42 | 25 | 19 | 11 | 0.11 |

As shown in Table 5, in sample No. 42, in which the arithmetic mean roughness (Ra) of the flow path surface exceeded 15 nm, the average of the flying height (flying amount) of the magnetic head was 11 nm, which was not significantly different from that of sample Nos. 40 and 41. However, in sample No. 42, since the arithmetic mean roughness (Ra) of the flow path surface was large, the flying height varied and the standard deviation thereof was as large as 0.11 nm.

In contract, as for the magnetic heads of sample Nos. 40 and 41 in which the arithmetic mean roughness (Ra) of the recess (flow path surface) was 15 nm or less, the average of the flying height (flying amount) was low, namely, 10 nm or less, and the standard deviation was also small, namely, 0.05 nm or less, indicating that the flying characteristics of these magnetic heads are stable.

Although exemplary embodiments of the present disclosure have been described above with reference to the accompanying drawings, it is understood that the present disclosure is not limited to the above-described embodiments. Various alterations and modifications to the above embodiments are contemplated to be within the scope of the disclosure. It should be understood that those alterations and modifications are included in the technical scope of the present disclosure as defined by the appended claims.

Terms and phrases used in this document, and variations hereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “existing,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

While at least one exemplary embodiment has been presented in the foregoing detailed description, the present disclosure is not limited to the above-described embodiment or embodiments. Variations may be apparent to those skilled in the art. In carrying out the present disclosure, various modifications, combinations, sub-combinations and alterations may occur in regard to the elements of the above-described embodiment insofar as they are within the technical scope of the present disclosure or the equivalents thereof. The exemplary embodiment or exemplary embodiments are examples, and are not intended to limit the scope, applicability, or configuration of the disclosure in any way. Rather, the foregoing detailed description will provide those skilled in the art with a template for implementing the exemplary embodiment or exemplary embodiments. It should be understood that various changes can be made in the function and arrangement of elements without departing from the scope of the disclosure as set forth in the appended claims and the legal equivalents thereof. Furthermore, although embodiments of the present disclosure have been described with reference to the accompanying Tables, it is to be noted that changes and modifications may be apparent to those skilled in the art. Such changes and modifications are to be understood as being included within the scope of the present disclosure as defined by the claims.

1. A substrate for a magnetic head, comprising:
a sinter comprising at least about 60% by mass and at most about 70% by mass alumina and at least about 30% by mass and at most about 40% by mass TiC_{X}O_{Y}N_{Z} where the X, Y and Z satisfy 0.5≦X≦0.993, 0.005≦Y≦0.30, 0.002≦Z≦0.20, and 0.507≦X+Y+Z≦1, wherein
a first value comprises a number of crystal grains of the TiC_{X}O_{Y}N_{Z} present on an arbitrary straight line having a length of at least about 10 μm on a cut surface of the sinter,
a second value comprises a total of the first value and a number of crystal grains of the alumina present on the arbitrary straight line, and
a proportion of the first value to the second value is at least about 55% and at most about 75%.

2. The substrate according to claim 1, wherein the number X, Y and Z satisfy the following relationships:
0.7≦X≦0.9;
0.02≦Y≦0.12; and
0.005≦Z≦0.07.

3. The substrate according to claim 1, wherein the crystal grains of the TiC_{X}O_{Y}N_{Z} in the sinter have an average crystal grain size of greater than zero and less than about 0.25 μm.

4. The substrate according to claim 3, wherein the crystal grains of the TiC_{X}O_{Y}N_{Z} in the sinter have an average crystal grain size of greater than zero and less than about 0.20 μm.

5. The substrate according to claim 1, wherein the sinter has a flexural strength of at least about 800 MPa.

6. The substrate according to claim 1, wherein a ratio (DA/DT) of an average crystal grain size (DA) of the crystal grains of the alumina to an average crystal grain size (DT) of the crystal grains of the TiC_{X}O_{Y}N_{Z} in the sinter is at least about 1 and at most about 2.

7. A magnetic head comprising:
a slider comprising a sinter, the sinter comprising
at least about 60% by mass and at most about 70% by mass alumina, and at least about 30% by mass and at most about 40% by mass TiC_{X}O_{Y}N_{Z} where the X, Y and Z satisfy 0.5≦X≦0.993, 0.005≦Y≦0.30, 0.002≦Z≦0.20, and 0.507≦X+Y+Z≦1, wherein
a first value comprises a number of crystal grains of the TiC_{X}O_{Y}N_{Z} present on an arbitrary straight line having a length of at least about 10 μm on a cut surface of the sinter,
a second value comprises a total of the first value and a number of crystal grains of alumina present on the arbitrary straight line, and
a proportion of the first value to the second value is at least about 55% and at most about 75%; and
an electromagnetic conversion element on the slider.

8. The magnetic head according to claim 7,
wherein the slider comprises a flying surface and a flow path surface operable to pass air, and
the flow path surface has an arithmetic mean roughness (Ra) of at most about 15 nm.

9. A recording medium drive device comprising:
a magnetic head comprising a slider and an electromagnetic conversion element on the slider, the magnetic head comprises:
a sinter comprising at least about 60% by mass and at most about 70% by mass alumina and at least about 30% by mass and at most about 40% by mass TiC_{X}O_{Y}N_{Z} where the X, Y and Z satisfy 0.5≦X≦0.993, 0.005≦Y≦0.30, 0.002≦X≦0.20, and 0.507≦X+Y+Z≦1, wherein
a first value comprises a number of crystal grains of the TiC_{X}O_{Y}N_{Z} present on an arbitrary straight line having a length of at least about 10 μm on a cut surface of the sinter,
a second value comprises a total of the first value and a number of crystal grains of alumina present on the arbitrary straight line, and
a proportion of the first value to the second value is at least about 55% and at most about 75%;
a recording medium comprising a magnetic recording layer operable to record and reproduce information using the magnetic head; and
a motor configured to drive the recording medium.

10. The recording medium drive device according to claim 9,
wherein the slider comprises a flying surface and a flow path surface operable to pass air, and
the flow path surface has an arithmetic mean roughness (Ra) of at most about 15 nm.

11. The recording medium drive device according to claim 9, wherein the crystal grains of the TiC_{X}O_{Y}N_{Z} in the sinter have an average crystal grain size of greater than zero and less than about 0.25 μm.

12. The recording medium drive device according to claim 11, wherein the crystal grains of the TiC_{X}O_{Y}N_{Z} in the sinter have an average crystal grain size of greater than zero and less than about 0.20 μm.
